(19) United States
(12) Patent Application Publication
(10) Pub. No.: US 2014/0039837 A1
(43) Pub. Date: Feb. 6, 2014

(54) SYSTEM AND METHOD FOR REMOTE MONITORING OF THE ORIENTATION OF A MESSAGE SIGN

(71) Applicants: Stephen P. Hart, Atlanta, GA (US); Christopher Geoffrey Webb, Roswell, GA (US)

(72) Inventors: Stephen P. Hart, Atlanta, GA (US); Christopher Geoffrey Webb, Roswell, GA (US)

(21) Appl. No.: 13/565,968

(22) Filed: Aug. 3, 2012

(51) Int. Cl. G06F 11/30

(52) U.S. Cl. CPC G06F 11/30
USPC 702/188

(57) ABSTRACT

System and method for monitoring a condition, such as directional orientation, of an object, such as a message sign, and generating an alert if the condition deviates from a predetermined minimum level. An apparatus associated with the object includes at least one sensor that provides initial and subsequent condition data. The apparatus transmits data to a remote monitoring station having a computer that can receive and store data. The computer calculates the difference in value between an initial condition data and subsequently obtained condition data, and compares the difference to a predetermined deviation value. If the difference value is greater than the predetermined deviation value the computer generates an alert. The alert may be displayed as an icon on a displayed map. An alert may be sent to a remote operator requesting correction of the condition, such as reorienting a sign face.

### FIELD

The present disclosure relates to a system and method for remote monitoring of an attribute or condition of an object and alerting a remote location in the event the attribute deviates from a minimum amount. More particularly, the present disclosure relates, in one exemplary embodiment, to a system and method for remotely monitoring the orientation of a portable message sign and alerting a remote monitor should the sign face be moved more than a predetermined minimum amount off-axis from the initially installed orientation.

### BACKGROUND

Portable roadside message signs must have their face oriented in a direction that maximizes the light from the sign lights visible by oncoming traffic. If the sign face is rotated or otherwise moved from the optimal orientation the amount of light reaching the oncoming traffic decreases dramatically, making the sign and message more difficult, if not impossible, to read. It would be desirable to have a system that could automatically detect the orientation of the sign face after installation. It would be desirable to have a system that could gather remotely information regarding the sign's conditions and alert a remote monitor if the sign face orientation, or other parameters, are outside of operating tolerances.

### SUMMARY

Generally described, the present disclosure provides in a first exemplary embodiment a system for remotely monitoring the directional orientation, or other attribute, of an object, such as, but not limited to, a portable roadside message sign. In one exemplary embodiment the system comprises a controller, at least one sensor, such as a compass, for detecting an initial attribute condition and subsequent attribute conditions, such as directional orientation of a sign face. The system may optionally include a memory storage device for storing initial and subsequent sensor readings. The system further includes a power source and transmitter for transmitting data to a remote location. The system also includes at least one remote monitoring station that includes a receiver for receiving data from the sign transmitter. The remote monitoring station may also include a transmitter for transmitting signals back to the sign controller, in which case the sign controller may also include a receiver. The remote monitoring station may also include a computer having a central processing unit, memory storage device, display and user interface or interfaces (which may be a touch screen interface, or keyboard, mouse or other conventional interface now known or hereafter developed).

In one exemplary embodiment a method is provided for remotely monitoring the directional orientation or other attribute of an object, such as a portable roadside message sign, the method comprising (a) detecting an initial attribute condition and defining initial condition data Z₀; (b) periodically obtaining subsequent attribute condition data Zₓ at various times; (c) transmitting data of Z₀ and Zₓ values to a remote monitoring station; (d) storing the data in a data storage device associated with the remote monitoring station; (e) periodically comparing the values of Zₓ to Z₀; (f) determining whether the difference Z_{D} in the value between Zₓ and Z₀ exceeds a predetermined value Z_{P}; (g) if Z_{D} is greater than Z_{P}, actuating an alarm condition enabling a signal to be transmitted alerting that the object has shifted in orientation and needs to be reoriented, but Z_{D} is not greater than Z_{P}, taking no action; (h) actuating a user-detectable alert to be in the “on” state; and, (i) polling periodically the values Zₓ and Z₀ whereby if Z_{D} is not greater than Z_{P} then the alert is reset to the off state, and whereby if Z_{D} is greater than Z_{P} then maintaining the alert state in the on state.

The method may also further include a step gg) after step g) if Z_{D} is greater than Z_{P}, generating a displayable map retrieved from a library data source. The method may also further include a step ggg) after step gg) displaying an icon on the map representing the geographic location of the object. The method may further include a step gggg) after step ggg) displaying a visible or audible alert associated with the icon when an alarm condition is actuated in step g). The method may further include a step j) after step i) removing or disabling the visible or audible alert after the alert is reset to the off state.

Other features will become apparent upon reading the following detailed description of certain exemplary embodiments, when taken in conjunction with the appended claims

### BRIEF DESCRIPTION OF THE DRAWINGS

The drawings disclose exemplary embodiments in which like reference characters designate the same or similar parts throughout the figures of which:

FIG. 1 a diagrammatic view of a road and signage apparatus, the sign face being shown oriented in respect to oncoming vehicles in an initial orientation (the sign being shown in solid line) and in a deviated orientation (the sign being shown in dashed line).

FIG. 2 is a schematic diagram of a system according to one exemplary embodiment of the present disclosure.

FIG. 3 is part 1 of 2 of a flow diagram according to one exemplary embodiment of a method of the present disclosure.

FIG. 4 is part 2 of 2 of a flow diagram according to one exemplary embodiment of a method of the present disclosure.

### DETAILED DESCRIPTION

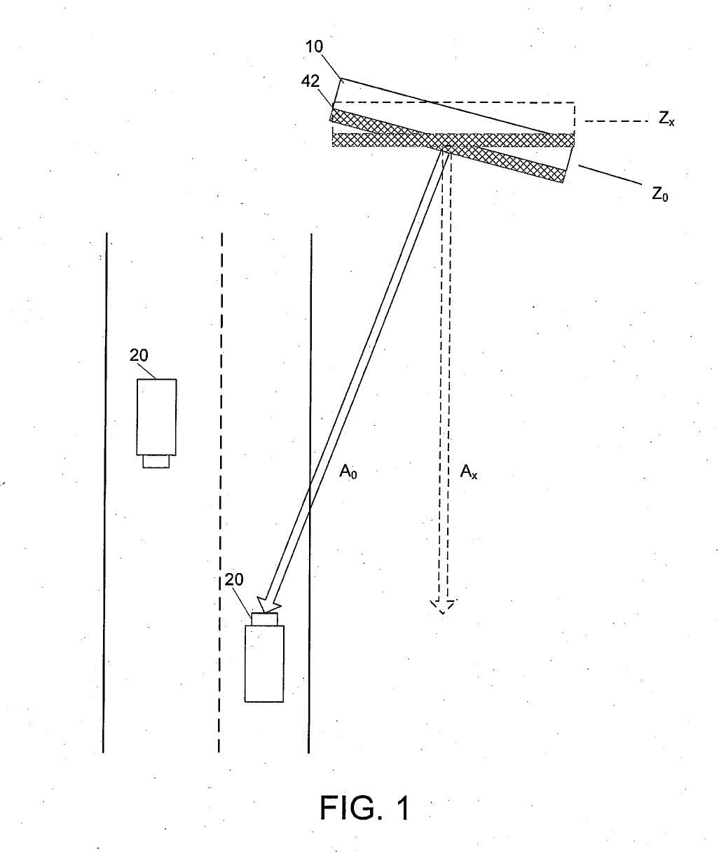

FIG. 1 shows a typical roadside installation configuration of a sign apparatus 10 having a sign face installed at an initial orientation indicated by line Z₀, in which the sign face is pointed toward oncoming vehicles. The sign face may intentionally or unintentionally be moved into a deviated orientation indicated by dashed line Zₓ. In the initial orientation Z₀, the sign apparatus 10 directs light (generally indicated by arrow A₀) emanating from the sign face message board toward oncoming vehicles 20. In the deviated orientation Zₓ, the light direction is indicated by dashed arrow Aₓ. As can be seen, the light from the sign face is not optimally directed toward oncoming vehicles and drivers may not be able to see the sign face message from as far away as would be possible with a properly oriented sign face.

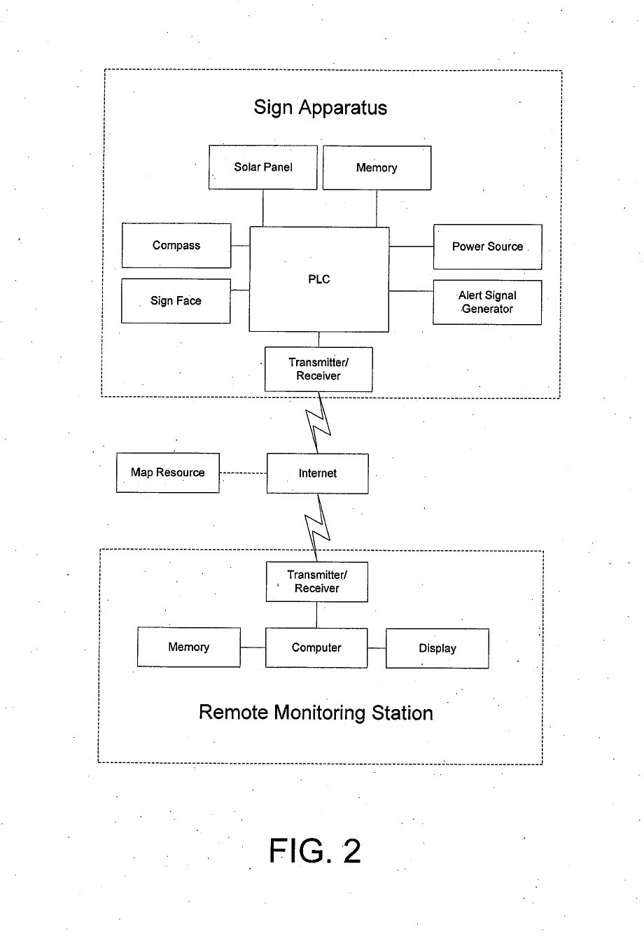

FIG. 2 shows one exemplary embodiment of a system 30 according to the present disclosure and including a sign apparatus 10 and a remote monitoring station 40 (it being understood that more than one monitoring station 40 may be include). The sign apparatus 20 has several components known to those skilled in the art and not shown in the drawings, such as a transport base (typically on wheels), a sign face mounted on a post connected to the base, optionally, a solar panel power source, and various electronics. Most of these components are typical and will not be discussed in detail herein. The sign face 42 is able to display a preprogrammed message using an array of LED, incandescent, halogen or other light bulbs or light sources. The sign face is oriented during installation so that it is able to be seen by persons in oncoming vehicles from relatively far away. If the sign is not oriented properly, the direction of the light is changed so that it is off-axis, which reduces the distance at which the person can read the sign. In many applications is important to maintain the maximum possible distance of visibility.

Also associated with the sign apparatus 10 is a power source 44. In one exemplary embodiment a battery 46 may be used. In one exemplary embodiment a solar panel 48 mounted on the sign apparatus 10 can provide power or recharging power to the battery 46. The sign apparatus 10 may also include a computer or programmable logic controller (PLC) 50 that may contain a memory storage device 52 (referred to as “memory 52”). In one exemplary embodiment the controller 50 has a memory storage device 52 associated therewith that can store data in the form of compass or other data point readings. The data readings can be stored in the memory storage device 52 and periodically transmitted to the remote monitoring station. In another exemplary embodiment the controller has no onboard memory storage device and the data is transmitted to the remote monitoring station each time a reading is obtained.

An alert signal generator 60 can provide an audible, visual, tactile and/or other alert signal. A transmitter 62 can transmit data from the computer 50. In one exemplary embodiment the transmitter 62 also incorporates a receiver 64 so that the sign apparatus 10 can both send and receive data. The transmitter is able to transmit data wirelessly via the internet or other communication network to the remote monitoring station 40.

The apparatus 10 also includes at least one sensor 70, such as a compass. In one exemplary embodiment the compass 70 is a digital compass, commercially available from any of several suppliers. The compass 70 is connected to the computer 50 and can provide a data signal with the compass direction indication of the sign face 42.

In exemplary embodiments, other devices and sensors can be incorporated into or associated with (internally or externally) the sign apparatus 10 that can provide information regarding various aspects of the state or condition of various parameters. For example, solar panel Z-axis tilt may be monitored by a tilt angle sensor (not shown) associated with the solar panel 48. Battery power and life may be monitored by an associated battery power sensor. Location information (e.g., ground position), for example, via an onboard GPS (global positioning satellite) device can be monitored in case the sign location changes. Altitude can be monitored by an altimeter sensor. In one exemplary embodiment, at least one snow, freezing rain, icing, hail, sleet or “propensity to ice” sensor (i.e., a sensor that detects temperature, humidity, dew point or other environmental conditions that can indicate a potential for formation of ice, snow, freezing rain, or the like), or combination of two or more of the foregoing may be incorporated to detect the presence of snow, freezing rain or ice (or the propensity of any of these to occur) on one or more areas of the sign apparatus 10, such as, but not limited to, the solar panel, the sign face, the sign mounting pole, or the like, or in the area proximate to the sign apparatus, such as the road, bridge or the like.

Sign current, solar current, message displayed, lamp outage or other properties, states, conditions or parameters may be detected, monitored, etc., by associated sensors or detectors, all of which can provide condition information to the computer 50. In some instances, a given device itself may have an onboard computer or PLC that can directly transmit data. In one exemplary embodiment several different sensors may be included to monitor a variety of conditions.

For illustrative purposes only a compass will be referred to as a representative example of a sensor in that a compass can detect geographic orientation with respect to magnetic North. Alternatively, instead of a digital compass, an analog compass may be used.

The remote monitoring station 40 includes at least one computer 80, at least one memory storage device 82, at least one display 84, and at least one transceiver 86 or device for communicating over the internet. In one exemplary embodiment the computer 80 can connect with and access an external map resource 88, such as, but not limited to, Google Maps or other available online map resource (or one internally developed).

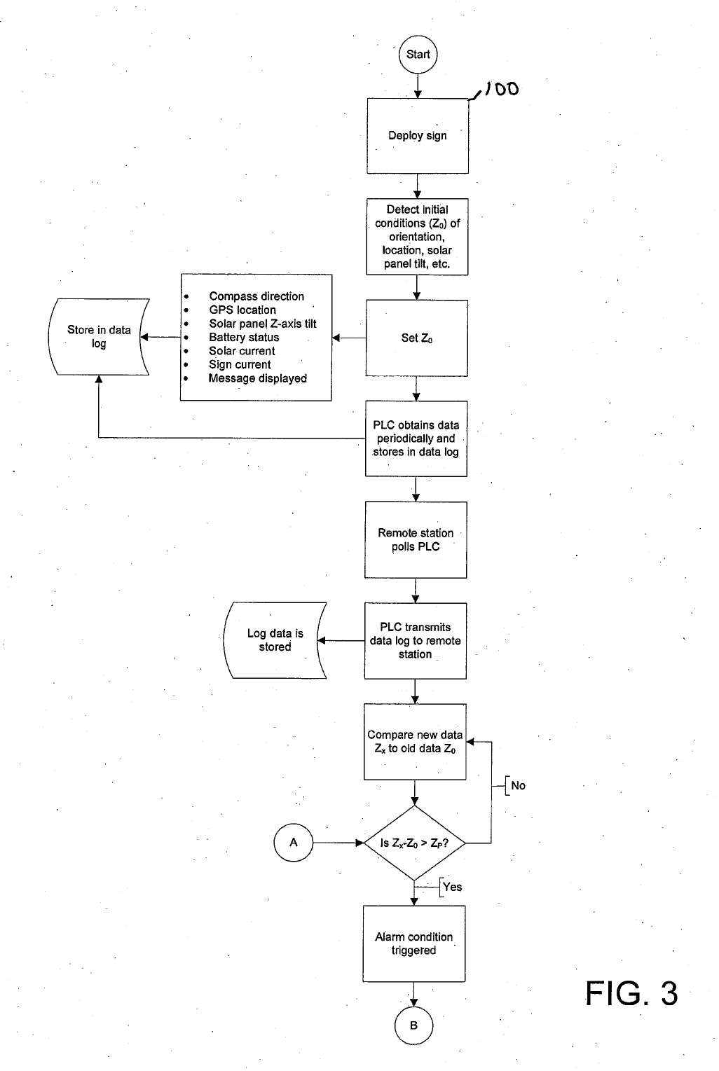

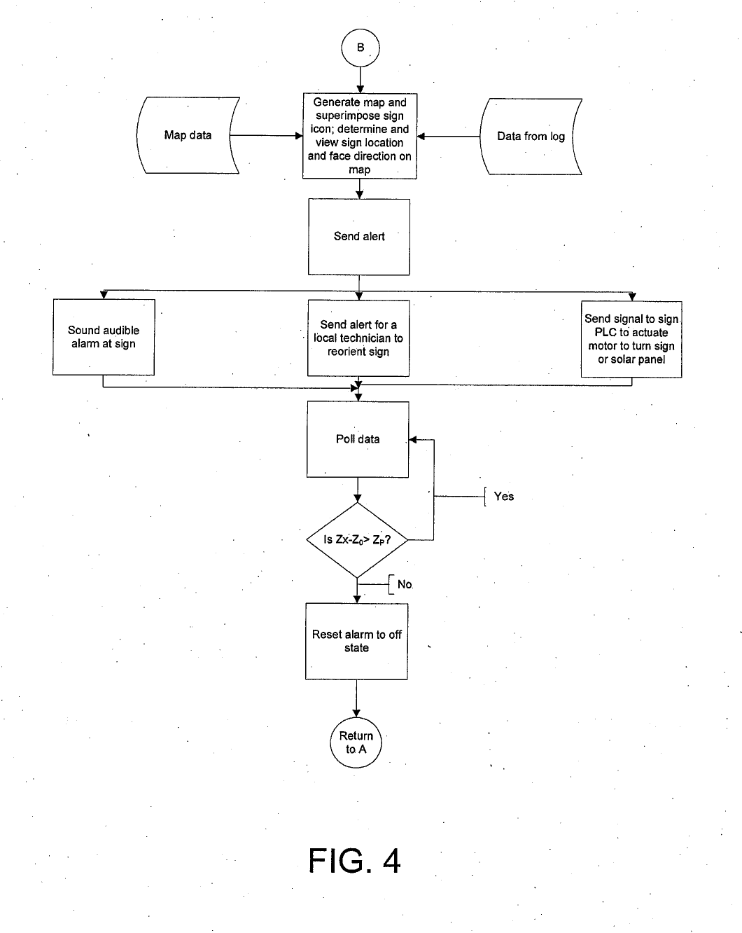

FIGS. 3-4 are flow diagrams illustrating a method according to one exemplary embodiment of the present disclosure. In this method a sign apparatus 10 is installed (block 100) at a given location, for example by the side of a road. The sign face 42 is oriented in the proper direction and other components are activated, as appropriate. The computer 50 takes an initial data reading from the compass 70 to establish an initial sign orientation Z₀ in the form of, for example, degrees. Reading Z₀ is stored in memory 52. The compass 70 periodically provides measurements Zₓ, each being of the then-current orientation of the sign face with respect to magnetic North.

The computer 50 may store the various readings Zₓ, in a data log file. In one exemplary embodiment the computer 50 periodically transmits (pushes) the data log file or relevant portions thereof via the transmitter 62 over the internet to the computer 80 at the remote monitoring station. Alternatively, in another exemplary embodiment, the computer 80 may periodically poll the computer 50 to pull the data log file information.

The data file received by the remote monitoring station 40 is stored in the memory storage device 82. Periodically, the computer 80 analyzes the data by comparing Zₓ to Z₀. If the difference Z_{D} between Zₓ and Z₀ is not greater than a predetermined amount Zₚ, then no action is taken and, after some predetermined period of time, another analysis is done. If, however, Z_{D} is greater than a predetermined level Zₚ, then an alarm condition is triggered, indicating that the sign face orientation has changed more than a threshold level and requires reorientation.

In one exemplary embodiment, if an alert is triggered the computer 80 accesses a map from the map resource 88 and displays the map on the display 84. The computer 80 causes one or more icons to be superimposed on the map, each icon indicating the location of a given sign and the current sign face orientation. The icon may also provide additional information on an attribute or condition by clicking or rolling over it, such as, but not limited to, current message, location (latitude/longitude), altitude, power level, and other operating conditions. The computer 80 causes one or more types of alerts to be sent or displayed. For example, an audible alert may be actuated at the computer 80 to alert a user at the monitoring station of a sign apparatus 10 that requires reorientation. The icon may display a color change, flash or provide some other type of visual indication of an alert. It is also possible that once an alert condition is encountered the computer 80 can transmit a signal back to the sign apparatus 10 that can cause an audible or visible alert to be actuated. An alert may be sent by computer 80 to instruct a technician that a sign needs to be reoriented. The alert may be sent to a remote location or to a remote operator in any of various forms, such as, but not limited to, an email, pager signal, telephone call, text message, combinations of the foregoing, or the like.

In one exemplary embodiment the sign apparatus 10 may have a motor (not shown) operatively associated with the sign apparatus that can be controlled remotely to rotate the sign face 42 back to Z₀.

When the sign face 42 has been reoriented back to the proper orientation the alert may be reset to off and the audible, visual or other alerts deactivated. The system continues to send or poll data log files periodically from the sign apparatus 10 to continue monitoring sign orientation or other data.

In one exemplary embodiment, a system is provided for remotely generating an alert that a condition of an object has deviated from an initial condition. The system comprises at least one sensor for sensing an initial condition Z₀ and subsequent conditions Zₓ of the object; transmitter for transmitting sensor data; and, at least one remote monitoring apparatus comprising a computer configured to provide means for receiving sensor data, calculating the difference in value Z_{D} between Zₓ and Z₀, comparing the difference in value Z_{D} to a predetermined minimum deviation tolerance value Z_{P}, and generating an alert if Z_{D} is greater than Z_{P}. In one exemplary embodiment the at least one sensor is as described hereinabove. The system of this embodiment may be manufactured and sold separate from the object and attached to or otherwise associated with the object.

In exemplary embodiments, a system as described in exemplary embodiments above is provided having a sign apparatus that incorporates at least one snow, freezing rain, icing, hail, sleet or “propensity to ice” sensor, or combination of two or more of the foregoing, each such sign apparatus acting as a node that is used in conjunction with a plurality of similar sign apparatus with such sensors, or in coordination with other sensors not associated with a sign apparatus (such as roadside sensors) to create a network of sensors, all in communication with one or more remote monitoring stations that can receive data from all the sensors and create a map of weather conditions detectable by the sensors. In one exemplary embodiment where an icing sensor is incorporated in the sign apparatus, a heating element, such as a heating coil or wire, may be incorporated into one or more areas of the sign apparatus, such as, but not limited to, the solar panel area. When ice or propensity to ice conditions are sensed, the sensor transmits a signal to the PLC. In one exemplary embodiment, the PLC can actuate the heating element so as to reduce or prevent the formation of ice on the solar panel. In one exemplary embodiment, the PLC transmits a signal to the remote monitoring station, which in turn may trigger an alarm that can cause either a manual or automatic response from the monitoring station or monitoring person causing a return signal to be sent to the sign apparatus PLC actuating the heating element. In one exemplary embodiment, the remote monitoring station can transmit a signal to other sign apparatus near the sign apparatus that transmitted the ice presence or propensity signal so that the nearby sign apparatus actuate their respective heating coils to prophylactically prevent ice formation of the various solar panels among the apparatus.

The presently disclosed system can be used in connection with apparatus other than signs, such as, but not limited to alignment of solar panels for optimum power collection. The presently described exemplary embodiments present a system and method that enables sign owners or users to avoid periodic on-site visits to assess proper orientation and allows more efficient remote monitoring.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used in the specification and the appended claims, the singular forms “a,” “an” an “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

It should further be noted that any patents, applications and publications referred to herein are incorporated by reference in their entirety.

What is claimed is:

1. A system for remotely monitoring the directional orientation or other attribute of an object, such as a portable roadside message sign, the system comprising:
a) a controller associated with the object;
b) at least one sensor for detecting an initial attribute condition and subsequent attribute conditions, the at least one sensor adapted to be in communication with the controller;
c) a transmitter for transmitting data to a remote location, the transmitter adapted to be in communication with the controller; and,
d) a power source in communication with the controller.

2. The system of claim 1, further comprising at least one monitoring station disposed remotely from the object and having
i) a receiver for receiving data from the transmitter,
ii) a display,
iii) a central processing unit,
iv) memory storage, and
v) at least one user interface.

3. The system of claim 2, further comprising a memory storage device associated with the controller.

4. The system of claim 1, wherein the at least one sensor comprises at least one sensor able to detect at least one condition selected from the group consisting of temperature, humidity, dew point, ice, rain, freezing rain, hail, sleet and combinations of at least two of the foregoing.

5. The system of claim 1, wherein the at least one sensor is a compass.

6. A system for remotely monitoring the directional orientation or other attribute of an object, such as a portable roadside message sign, the system comprising:
a) a controller associated with the object;
b) a memory storage device associated with the controller
c) at least one sensor for detecting an initial attribute condition and subsequent attribute conditions, the at least one sensor adapted to be in communication with the controller;
d) a transmitter for transmitting data to a remote location, the transmitter adapted to be in communication with the controller;
e) a power source in communication with the controller;
f) at least one monitoring station disposed remotely from the object and having
i) a receiver for receiving data from the transmitter,
ii) a display,
iii) a central processing unit,
iv) memory storage, and
v) a user interface.

7. The system of claim 6, wherein the at least one sensor comprises at least one compass.

8. A system for remotely generating an alert that a condition of an object has deviated from an initial condition, the system comprising:
a) at least one sensor associated with the object for sensing an initial condition Z₀ and subsequent conditions Zₓ;
b) transmitter for transmitting sensor data;
c) at least one remote monitoring apparatus comprising a computer configured to provide means for receiving sensor data, calculating the difference in value Z_{D} between Zₓ and Z₀, comparing the difference in value Z_{D} to a predetermined minimum deviation tolerance value Z_{P}, and generating an alert if Z_{D} is greater than Z_{P}.

9. The system of claim 8, wherein the at least one sensor comprises at least one compass.

10. The system of claim 8, wherein the computer further includes a display that can display a map and an icon representing the location and other information of one or more objects being monitored.

11. A method for remotely monitoring the directional orientation or other attribute of an object, such as a portable roadside message sign, the method comprising:
a) detecting an initial attribute condition and defining initial data Z₀;
b) storing the data Z₀ in a first data storage device;
c) periodically obtaining subsequent attribute condition data Zₓ at various times and storing the data in the first data storage device;
d) remotely communicating with the first data storage device;
e) transmitting stored data to a remote monitoring station;
f) storing the data in a second data storage device associated with the remote monitoring station;
g) periodically comparing the values of Zₓ to Z₀;
h) determining whether the difference Z_{D} in the value between Zₓ and Z₀ exceeds a predetermined value Z_{P};
i) if Z_{D} is greater than Z_{P}, actuating an alarm condition enabling a signal to be transmitted alerting that the object has shifted in orientation and needs to be reoriented, but Z_{D} is not greater than Z_{P}, taking no action;
j) actuating a user-detectable alert to be in the “on” state;
k) polling periodically the values Zₓ and Z₀ whereby if Z_{D} is not greater than Z_{P} then the alert is reset to the off state, and whereby if Z_{D} is greater than Z_{P} then maintaining the alert state in the on state.

12. The method of claim 11, further comprising a step ii) after step i) if Zₓ−Z₀ is greater than Z_{P}, generating a displayable map retrieved from a library data source.

13. The method of claim 12, further comprising a step iii) after step ii) displaying an icon on the map representing the geographic location of the object.

14. The method of claim 13, further comprising a step iiii) after step iii) displaying a visible or audible alert associated with the icon when an alarm condition is actuated in step i).

15. The method of claim 11, further comprising a step l) after step k) removing the visible or audible alert after the alert is reset to the off state.

16. The method of claim 11, wherein in step d) the data is pushed.

17. The method of claim 11, wherein in step d) the data is pulled.

18. The method of claim 11, wherein the attribute is direction.

19. The method of claim 11, wherein the direction is detected by a compass.

20. A method for remotely monitoring the directional orientation or other attribute of an object, such as a portable roadside message sign, the method comprising:
a) detecting an initial attribute condition and defining initial data Z₀;
b) periodically obtaining subsequent attribute condition data Zₓ at various times;
c) transmitting data of Z₀ and Zₓ values to a remote monitoring station;
d) storing the data in a data storage device associated with the remote monitoring station;
e) periodically comparing the values of Zₓ to Z₀;
f) determining whether the difference Z_{D} in the value between Zₓ and Z₀ exceeds a predetermined value Z_{P};
if Z_{D} is greater than Z_{P}, actuating an alarm condition enabling a signal to be transmitted alerting that the object has shifted in orientation and needs to be reoriented, but if Z_{D} is not greater than Z_{P}, taking no action;
h) actuating a user-detectable alert to be in the “on” state; and,
polling periodically the values Zₓ and Z₀ whereby if Z_{D} is not greater than Z_{P} then the alert is reset to the off state, and whereby if Z_{D} is greater than Z_{P} then maintaining the alert state in the on state.

21. The method of claim 20, further comprising a step gg) after step g) if Z_{D} is greater than Z_{P}, generating a displayable map retrieved from a library data source.

22. The method of claim 21, further comprising a step ggg) after step gg) displaying an icon on the map representing the geographic location of the object.

23. The method of claim 22, further comprising a step gggg) after step ggg) displaying a visible or audible alert associated with the icon when an alarm condition is actuated in step g).

24. The method of claim 20, further comprising a step j) after step i) removing or disabling the visible or audible alert after the alert is reset to the off state.
